(19) United States
(12) Patent Application Publication
(10) Pub. No.: US 2007/0147731 A1
(43) Pub. Date: Jun. 28, 2007

(54) Analogue navigation device

(76) Inventor: Philip Barrowclough, Hampshire (GB)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/583,986

(22) PCT Filed: Dec. 21, 2004
(86) PCT No.: PCT/IB04/04388

§ 371 Date: Jun. 22, 2006

(30) Foreign Application Priority Data
Dec. 24, 2003 (GB) 0330055.5

(51) Int. Cl. G02B 6/26; G02B 6/42

(52) U.S. Cl. 385/18

(57) ABSTRACT

An analogue navigation device comprising a transmitter for generating a light signal, a receiver for receiving the light signal, a light guide having a surface for internally reflecting the light signal from the transmitter to the receiver, and an actuator having a surface, said actuator surface having at least a portion which is movable between a first position in which it is spaced apart from a portion of said light guide surface with a gas or fluid therebetween. and a second position in which it is in contact with said portion of said light guide surface, said portion of said light guide surface having a higher refractive index than said portion of said actuator surface and said portion of said actuator surface having a different refractive index than said gas or fluid, whereby in use the relative refractive index is changed at the contacted portion of the light guide surface thereby altering the light signal received by the receiver, said received signal being used to control the position of an element.

### FIELD OF INVENTION

The present invention relates to an analogue navigation device. Particularly, but not exclusively, the present invention relates to an analogue navigation device for use in a mobile electronic device.

### BACKGROUND OF THE INVENTION

Analogue navigation devices are utilised in a number of different types of mobile product with applications such as: pointing, navigating and selecting (e.g. browsing on web pages); drawing sketches; marking maps with lines; game play; radio controlled devices; and editing and manipulating pictures.

Known analogue navigation devices include joysticks, touchpads, mice (ball and optical types), arrow keys, navigating disks (arrowed disks) etc. The technologies used in these known analogue navigation devices include the Hall Effect (magnetic), resistive plates (touchpad technology), resistive material (carbon impregnated silicone), capacitive pads and optical solutions. Previous optical solutions are reflective only. FIG. 1 illustrates the principle behind previous optical solutions. In these arrangements, an object (e.g. a users finger) or a pattern reflects transmitted light to a sensor/receiver. The amount of light reflected by the object is a function of the distance from the transmitter. With illustrated pattern, the amount of light reflected back is a function of the colour.

Problems with the above-mentioned known analogue navigation devices are: high cost; high power; large size (in particular the devices can be of too large a height to incorporate in mobile devices); and the devices may not be durable enough for integration into mobile products.

### SUMMARY OF THE INVENTION

An aim of the embodiments described hereinafter is to solve the problems defined above.

According to the present invention there is provided an analogue navigation device comprising a transmitter for generating a light signal, a receiver for receiving the light signal, a light guide having a surface for internally reflecting the light signal from the transmitter to the receiver, and an actuator having a surface, said actuator surface having at least a portion which is movable between a first position in which it is spaced apart from a portion of said light guide surface with a gas or fluid therebetween, and a second position in which it is in contact with said portion of said light guide surface, said portion of said light guide surface having a higher refractive index than said portion of said actuator surface and said portion of said actuator surface having a different refractive index than said gas or fluid, whereby in use the relative refractive index is changed at the contacted portion of the light guide surface thereby altering the light signal received by the receiver.

According to another aspect of the present invention there is provided a hand held electronic device comprising an analogue navigation device as defined above.

The actuator surface may be exposed at the exterior of the device. The actuator surface may be actuable, most preferably manually actuable—e.g. by finger pressure—by a user of the device. The actuator surface may be actuable by a user via a key of the device. The key may be part of a keypad.

According to another aspect of the present invention there is provided a method of navigating comprising generating a light signal and reflecting the light signal off a surface, wherein the relative refractive index between materials on either side of the surface is changed thereby altering the reflected light signal, said reflected light signal being received and used to control the position of an element.

According to another aspect of the present invention there is provided a key device comprising a transmitter for generating a light signal, a receiver for receiving the light signal, a light guide having a surface for internally reflecting the light signal from the transmitter to the receiver, and an actuator having a surface, said actuator surface having at least a portion which is movable between a first position in which it is spaced apart from a portion of said light guide surface with a gas or fluid therebetween, and a second position in which it is in contact with said portion of said light guide surface, said portion of said light guide surface having a higher refractive index than said portion of said actuator surface and said portion of said actuator surface having a different refractive index than said gas or fluid, whereby in use the relative refractive index is changed at the contacted portion of the light guide surface thereby altering the light signal received by the receiver.

Embodiments of the present invention use known optical properties of a light guide to internally reflect light. Embodiments of the present invention differ from previous implementations in that they use an actuator (e.g. a silicone rubber actuator) in conjunction with the light guide to alter the relative refractive index of the light guide and the substance forming an interface with the light guide thereby altering the reflective properties of the light guide.

Embodiments of the present invention solve the above-identified problems by providing a low-cost, low-power, small size, durable navigation device suitable for integration into mobile products. While previous optical solutions for analogue navigation utilise reflective techniques, embodiments of the present invention rely on changing the refractive index of a light guide. Embodiments of the present invention may work using standard IR and visible LEDs. A preferred embodiment uses HALIOS (high ambient light independent optical system) technology.

Embodiments of the present invention have an advantage over prior arrangements in that embodiments of the present invention use non-contact sensing thus increasing the durability of the device. That is, embodiments of the present invention function by contacting the surface of the light guide with the actuator and the sensor (receiver) is not contacted. This is in contrast to some other technologies in which the sensor is contacted in use thus damaging the sensor over time. For example, resistive touchpads function by contacting the surface of the element doing the sensing.

Embodiments of the present invention can also be made waterproof and use little power. Accordingly, embodiments of the present invention are ideal for utilisation in mobile products.

### BRIEF DESCRIPTION OF THE DRAWINGS

For a better understanding of the present invention and to show how the same may be carried into effect, reference will now be made by way of example to the accompanying drawings, in which:

FIG. 1 illustrates the principle behind prior art optical solutions;

FIG. 2 shows a side view of a light guide reflecting light from a transmitter (an LED) to a receiver (a photo detector);

FIG. 3 shows the light guide of FIG. 2 with an actuator touching the surface of the light guide;

FIG. 4 shows a graph indicating how the output voltage from the photodetector in FIGS. 2 and 3 decreases in size when the actuator touches the light guide surface;

FIG. 5 shows a plan view of an arrangement of LEDs and a photodetector in an optical analogue navigation device according to an embodiment of the present invention;

FIG. 6 shows a side view of the embodiment of FIG. 5 comprising a light guide, an actuator having a hemispherical surface, a plurality of transmitters (LEDs) and a receiver (photodetector);

FIG. 7 shows the embodiment of FIGS. 5 and 6 with the hemispherical surface of the actuator contacting the light guide surface;

FIG. 8 shows the embodiment of FIGS. 5 to 7 with the actuator displaced to one side;

FIG. 9 shows another embodiment in which an optical grating has been provided on the light guide thereby increasing the efficiency of the system;

FIG. 10 illustrates how a light guide may function to change the angle of incidence and the resultant effect on the amount of light refracted and internally reflected;

FIG. 11 is a side view of an optical analogue joystick according to an embodiment of the present invention;

FIG. 12 is a side view of an optical analogue navigating disk according to another embodiment of the present invention;

FIG. 13 is a top side view of a printed wiring board for use with embodiments of the present invention;

FIG. 14 is a bottom side view of the printed wiring board shown in FIG. 13;

FIG. 15 shows a bottom-side view of an alternative actuator form according to an embodiment of the present invention;

FIG. 16 shows a top-side view of the actuator in FIG. 15; and

FIG. 17 shows a cross-sectional view from the bottom-side of the actuator shown in FIGS. 15 and 16.

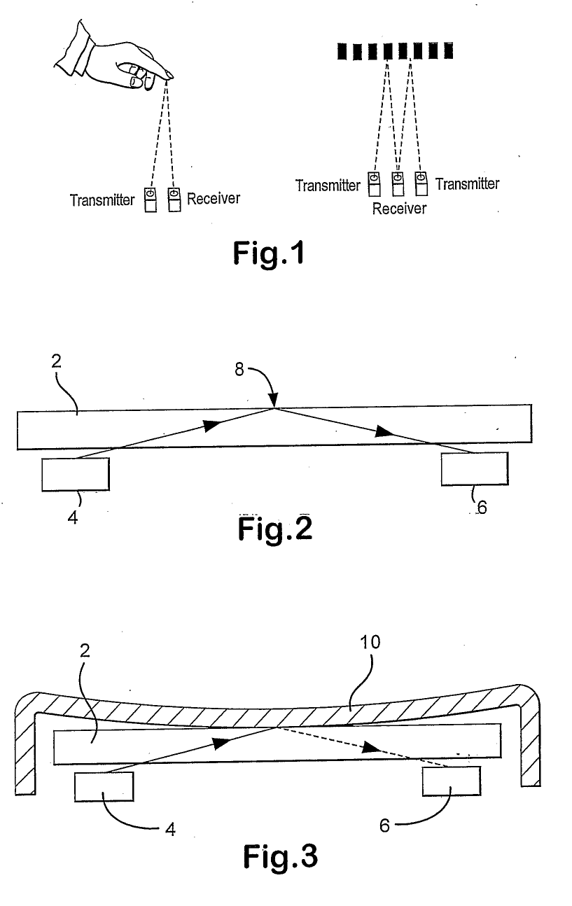

### DETAILED DESCRIPTION OF THE EMBODIMENTS OF THE INVENTION

The principles of the present invention will now be described with reference to FIGS. 2 to 4.

FIG. 2 shows how a light guide 2 can be used to reflect light from a transmitter or transmitter 4 (e.g. an infrared or visible LED) to a receiver 6 (e.g. a photo detector). The absolute refractive index of the light guide (n₁) is greater than the absolute refractive index of the air above it (n₂). The critical angle (θ_{c}) for total internal reflection can be found from Snell's law, putting in an angle of 90° for the angle of the refracted ray. This gives: sin θ_{c}=n₂/n₁, where n₁>n₂. The greater the difference between n₁ and n₂ (i.e. the smaller the relative refractive index n*=n₂/n₁), the smaller the critical angle resulting in more light striking a surface portion 8 at an angle greater than θ_{c} and being internally reflected.

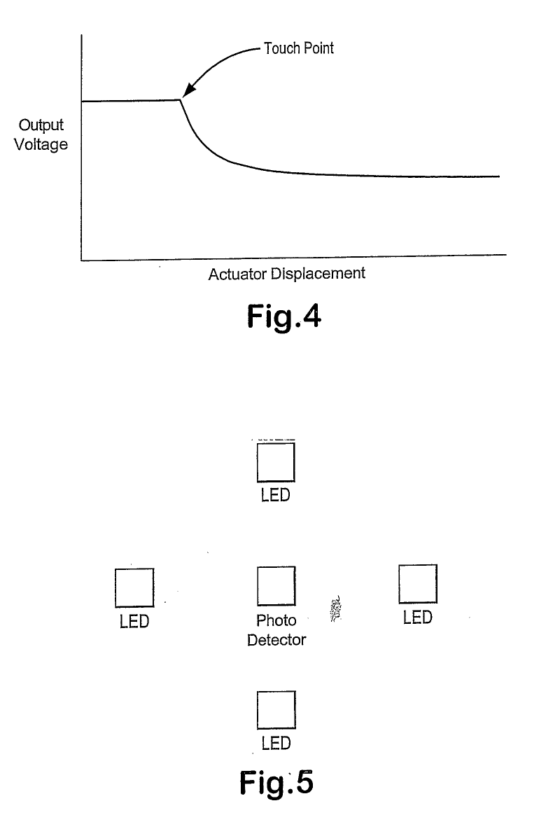

FIG. 3 shows how the effect of touching an actuator 10 on the surface of the light guide 2 reduces the signal to the receiver 6. The absolute refractive index of the material of the actuator is larger than the absolute refractive index of air. Accordingly, the relative refractive index n* is increased and the critical angle increases changing the reflective properties of the light guide. Without the actuator in contact with the light guide there is a large difference between the refractive index of the light guide and the air resulting in the majority of the light being internally reflected within the light guide. When the actuator touches the surface of the light guide there is a much closer match between the refractive index of the actuator and the light guide and so much less light is internally reflected and the received output signal is significantly reduced. FIG. 4 shows how the output voltage from the photodetector decreases when the actuator touches the light guide surface.

An embodiment of the present invention will now be described with reference to FIGS. 5 to 8.

FIG. 5 shows how LEDs and a photodetector can be laid out to produce a navigation device. Opposing LEDs are pulsed alternatively and the photodetector measures the internal reflection level from the light guide.

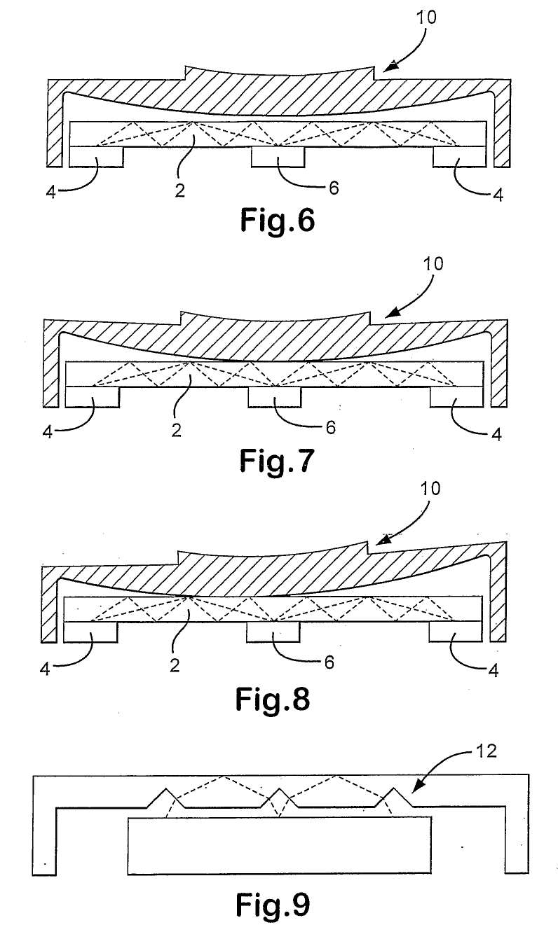

FIG. 6 shows how an actuator 10 with a hemispherical surface can be positioned above the light guide 2 but not in contact with it. Air is disposed between the actuator and the light guide although some other gas/fluid other than air may be utilized. The actuator is made of a material (e.g. silicone) which has an absolute refractive index higher than air (or other gas/fluid) but lower than the refractive index of the light guide. The actuator is movable between a position in which it is separated from the light guide (shown in FIG. 6) to a position in which it is directly adjacent the upper surface of the light guide or in contact with the light guide. The actuator may be rigid and movable between the first and second positions via a moving mechanism such as a hinging mechanism. Alternatively, the actuator may be made of a deformable material so as to be movable between the first position and the second position. The actuator is biased towards the first position so that when the actuator is not depressed by a user it automatically moves to the first position. In one embodiment the actuator is made of silicone rubber.

FIG. 7 shows how touching the actuator causes the hemispherical surface to contact the light guide surface. With the actuator in the second position, the relative refractive index is increased and the amount of reflected light is decreased. As a result, the output voltage from the photodetector decreases.

FIG. 8 shows how rocking the actuator button, as during cursor navigation, causes the hemispherical surface to roll along the light guide surface. The subsequent reduction in the amount of light internally reflected by the waveguide from the relevant LED or LEDs is then used to calculate the position of the area touching the surface. This in turn is used to calculate and control the position of an object (e.g. on a display). In addition to this, when using a deformable material for the actuator, varying the amount of pressure used to navigate alters the size of the area in contact with the light guide again reducing the amount of light internally reflected by the light guide. This system is therefore pressure sensitive. The sensitivity to pressure will depend on the type of material used for the actuator with harder materials being less pressure sensitive and softer materials being more pressure sensitive. The type of material for the actuator may therefore be selected according to the particular implementation according to how sensitive to pressure the device is intended to be. Alternatively, it may be possible to vary the pressure sensitivity within a single device. In this case, if the user wishes the device to have no pressure sensitivity, a setting may be selected such that a controller processes the information from the photodetector in such a way as to calculate the centre point of the area touching the light guide surface and control the position of an object (e.g. on a display) according to this middle point of contact. Alternatively, selecting a pressure sensitive setting may result in the device functioning such that, for example, when a larger area contacts the light guide as a result of an increase in pressure applied to the actuator, the speed of an object on a display controlled by the device increases. Thus, for example, when a user pushes the actuator to the left the object on the display moves to the left. If the user increases the pressure, the contact area increases and the object on the display moves to the left more quickly in response.

In an alternative arrangement to that described above with reference to FIGS. 6 to 8, the first position (i.e. the rest position) may be defined as that shown in FIG. 7 such that in its un-actuated/rest state the actuator contacts the light guide at, for example, its central position and by rocking the actuator as shown in FIG. 8, the position of an object is calculated and controlled. This alternative arrangement negates the need to depress the actuator. The actuator is in contact with the light guide at all times (although a portion of the actuator is still movable from a position spaced apart from the light guide to a position in contact with the light guide). This may improve user function and increase reaction time in, for example, game play.

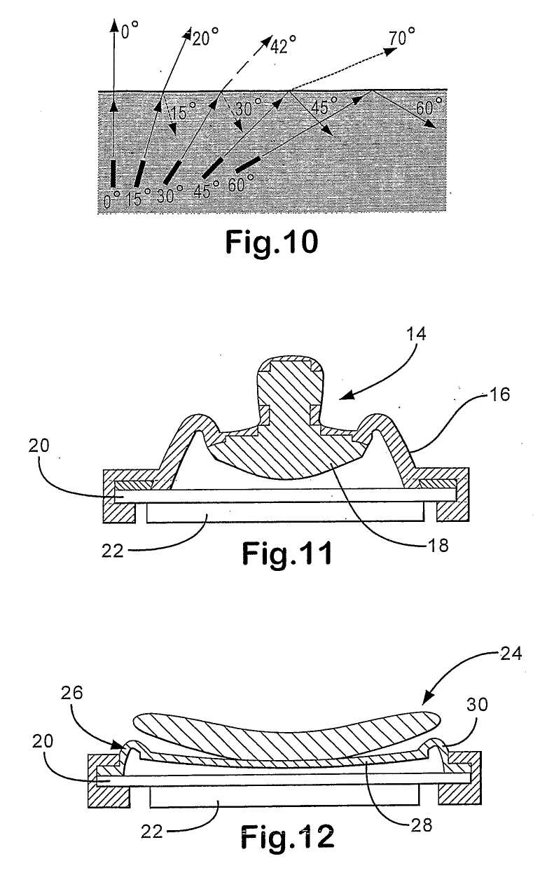

FIG. 9 shows an alternative embodiment in which an optical grating 12 has been provided on the light guide so as to increase the efficiency of the system. Providing a grating on to the light guide changes the effective angle of incidence allowing more internal reflection. FIG. 10 illustrates how a light guide may function to change the angle of incidence and the resultant effect on the amount of light refracted and internally reflected. As the angle of incidence increases the amount of refracted light passing through the interface decreases, and the amount of light being internally reflected increases until all the light is internally reflected. Accordingly, a light guide can be provided to increase the effective angle of incidence thus increasing the amount of light internally reflected to the sensor/receiver and increasing the efficiency of the system.

FIG. 11 shows an optical analogue joystick which functions in the aforementioned manner and comprises an actuator element having an upper portion in the form of a stick 14 for actuation by a user. The actuator element has side walls 16 supporting the stick portion. The side walls are deformable thereby allowing the stick portion to be movable both up and down and from side to side. The actuator element has a lower portion 18 comprising a substantially hemispherical surface for contacting a light distribution layer 20 (light guide), an upper surface of which is disposed adjacent, and spaced apart from, the hemispherical surface. On actuation of the stick portion 14 by a user, the side walls deform 16 and the hemispherical surface contacts the upper surface of the light distribution layer. An optical component layer 22 is disposed at a lower side of the light distribution layer, said lower side being opposite to said upper side. The optical component layer comprises emitter(s) and receiver(s) for emitting light into the light distribution layer and receiving light from the distribution layer respectively.

FIG. 12 shows an alternative arrangement in which the actuator element is in the form of a knob or disk 24. The knob/disk 24 is disposed on a deformable element 26 having an intermediate portion 28 which is supported by side walls 30. At least one of the side walls and the intermediate portion are deformable. Preferably both the side walls and the intermediate portion are deformable. The intermediate portion has a lower surface for contacting a light distribution layer 20 (light guide), an upper surface of which is disposed adjacent, and spaced apart from, the lower surface. On actuation of the disk/knob by a user, the deformable element deforms and the lower surface contacts the upper surface of the light distribution layer. An optical component layer 22 is disposed at a lower side of the light distribution layer, said lower side being opposite to said upper side. The optical component layer comprises emitter(s) and receiver(s) for emitting light into the light distribution layer and receiving light from the distribution layer respectively.

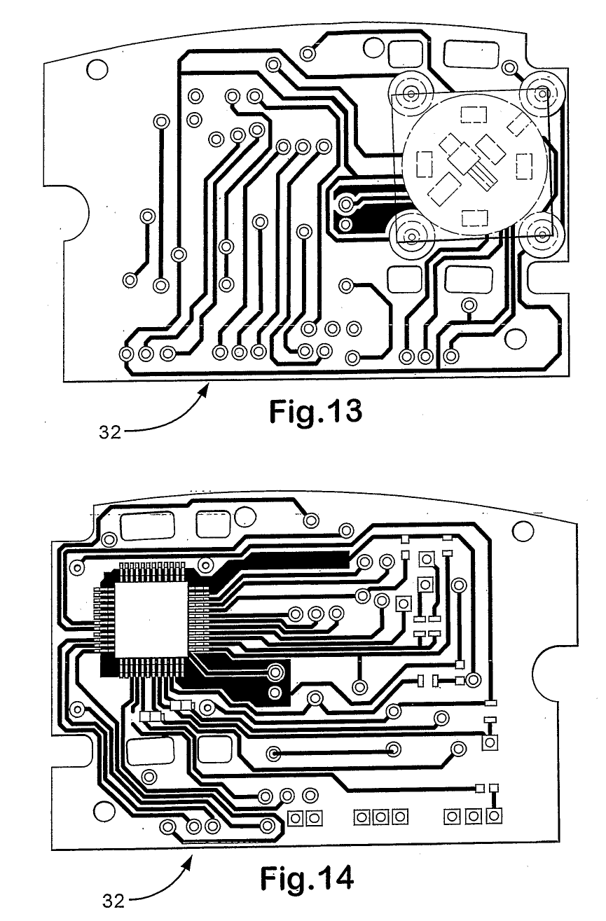

FIGS. 13 and 14 show top and bottom side views respectively of a printed wiring board for used in the previously described optical analogue navigation devices. The printed wiring board 32 comprises optical elements with discrete optical components and preferably has a height of 1.6 mm or less, more preferably 1.3 mm or less, and more preferably still 1.1 mm or less. The area of the printed wiring board is preferably 20 mm×20 mm or less, more preferably 15 mm×15 mm, and more preferably still 12 mm×12 mm or less. Accordingly, a very small, very slim optical device is provided for use in a mobile product.

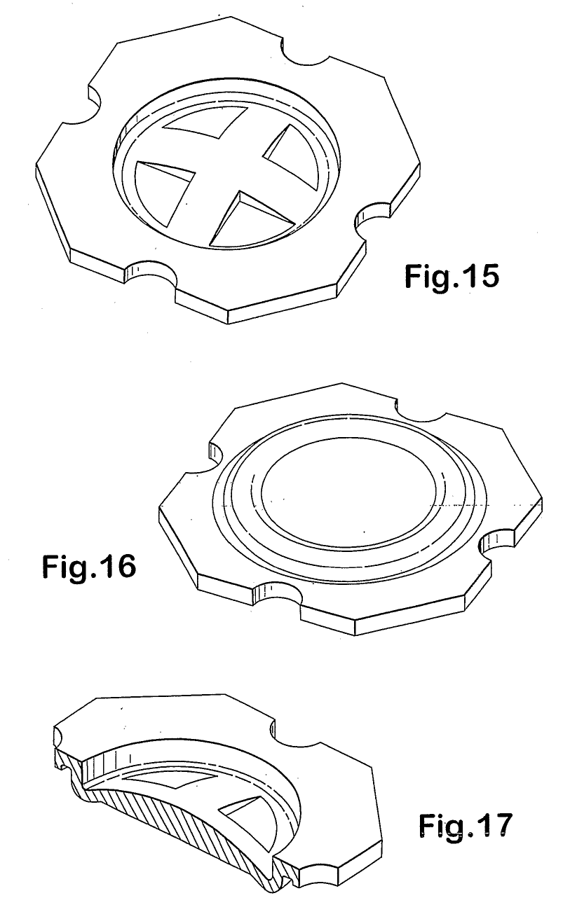

FIG. 15 shows a bottom-side view and FIG. 16 shows a top-side view of an alternative actuator form according to an embodiment of the present invention. FIG. 17 shows a cross-sectional view from the bottom-side of the embodiment shown in FIGS. 15 and 16. In this embodiment, the hemispherical surface of the actuator has a cross shape cut therein which may improve accuracy. In alternative embodiments, the actuator shape may be other than hemispherical e.g. ellipsoid, paraboloid, hyperboloid, toroid, etc.

According to another aspect of the present invention, the principles discussed above in relation to an analogue navigation device may be applied to a key device such as a keypad of a phone, a keyboard or buttons/keys on a game device. Such a device may comprise a key as the actuator or may comprise a key and a separate actuator disposed below the key. A light guide is provided below the key/actuator and the actuation of a key results in a change in the relative refractive index as discussed in relation to the navigation devices. In a device having a plurality of keys, the actuation of different keys will result in the light guide being contacted at different positions thereby altering the light signal received by a receiver. The receiver may then output a signal indicative of which key was depressed. Each of the keys may have a different function.

While this invention has been particularly shown and described with reference to preferred embodiments and described with references to preferred embodiments thereof, it will be understood by those skilled in the art that various changes in form and details may be made therein without departing from the scope of the invention as defined by the appended claims.

1-36. (canceled)

37. An analog navigation device, comprising:
a transmitter configured to generate a light signal;
a receiver configured to receive the light signal;
a light guide having a surface for internally reflecting the light signal from the transmitter to the receiver; and
an actuator having an actuator surface, said actuator surface having at least a portion which is movable between a first position spaced apart from a portion of said light guide surface, with a gas or fluid therebetween, and a second position which is in contact with the portion of the light guide surface,
wherein the portion of the light guide surface has a higher refractive index than the portion of the actuator surface, and wherein the portion of the actuator surface has a different refractive index than the gas or fluid, and wherein in use the relative refractive index is changed at a contacted portion of the light guide surface, thereby altering the light signal received by the receiver.

38. An analog navigation device as recited in claim 37, wherein the receiver is configured to output a signal indicative of the position of the contacted portion of the light guide surface.

39. An analog navigation device according to claim 37, wherein the receiver is configured to use the received signal to control a position of an element.

40. An analog navigation device according to claim 37, wherein the second position is at a selected one of a plurality of portions on the surface of the light guide.

41. An analog navigation device according to claim 37, wherein a plurality of transmitters is provided.

42. An analog navigation device according to claim 41, wherein the transmitters are arranged to pulse alternatively.

43. An analog navigation device according to claim 37, wherein a plurality of receivers is provided.

44. An analog navigation device according to claim 37, wherein the transmitter comprises an LED.

45. An analog navigation device according to claim 37, wherein the receiver comprises a photodiode.

46. An analog navigation device according to claim 37, wherein four transmitters and a single receiver are provided in a cross configuration having four corners and a center, each one of the transmitters being disposed at one of the comers and the receiver being disposed at the center.

47. An analog navigation device according to claim 37, wherein the light guide includes an optical grating.

48. An analog navigation device according to claim 37, wherein said surface of said actuator comprises a hemispherical surface.

49. An analog navigation device according to claim 37, wherein said surface of said actuator is supported by one or more side walls.

50. An analog navigation device according to claim 49, wherein said one or more side walls are deformable.

51. An analog navigation device according to claim 37, wherein said surface of said actuator is deformable.

52. An analog navigation device according to claim 37, wherein said actuator has an upper portion in the form of a stick for actuation by a user.

53. An analog navigation device according to claim 37, wherein said actuator comprises an arcuate disk disposed on said surface of said actuator.

54. An analog navigation device according to claim 37, wherein the transmitter and the receiver are disposed in a layer on an opposite side of said light guide to said actuator.

55. An analog navigation device according to claim 37, further comprising a processing device for processing the or each signal received by the or each receiver and outputting a control signal to control the position of the element.

56. An analog navigation device according to claim 37, further comprising a display for displaying an element, whereby in use the position of the element on the display is controlled.

57. An analogue navigation device according to claim 37, wherein said received signal is used to produce a radio signal for controlling a radio controlled device.

58. An analog navigation device according to claim 37, wherein the actuator surface is exposed at the exterior of the device.

59. A hand held electronic device according to claim 37, wherein the actuator surface is manually actuable by a user of the device.

60. A hand held electronic device, comprising:
a transmitter configured to generate a light signal;
a receiver configured to receive the light signal;
a light guide having a surface for internally reflecting the light signal from the transmitter to the receiver; and
an actuator having an actuator surface, said actuator surface having at least a portion which is movable between a first position spaced apart from a portion of said light guide surface, with a gas or fluid therebetween, and a second position which is in contact with the portion of the light guide surface,
wherein the portion of the light guide surface has a higher refractive index than the portion of the actuator surface, and wherein the portion of the actuator surface has a different refractive index than the gas or fluid, and wherein in use the relative refractive index is changed at a contacted portion of the light guide surface, thereby altering the light signal received by the receiver.

61. A hand held electronic device as claimed in claim 60, wherein the actuator surface is exposed at the exterior of the device.

62. A hand held electronic device as claimed in claim 61, wherein the actuator surface is manually actuable by a user of the device.

63. A hand held electronic device as claimed in claim 61, wherein the actuator surface is actuable by a user via a key of the device.

64. A hand held electronic device as claimed in claim 63, wherein the key comprises part of a keypad.

65. A method of navigating, said method comprising:
generating a light signal; and
reflecting the light signal off a surface,
wherein a relative refractive index between materials on either side of the surface is changed, thereby altering the reflected light signal, the reflected light signal being received and used to control a position of an element.

66. A key device, comprising:
a transmitter configured to generate a light signal;
a receiver configured to receive the light signal;
a light guide having a surface for internally reflecting the light signal from the transmitter to the receiver; and
an actuator having an actuator surface, said actuator surface having at least a portion which is movable between a first position spaced apart from a portion of said light guide surface, with a gas or fluid therebetween, and a second position which is in contact with the portion of the light guide surface,
wherein the portion of the light guide surface has a higher refractive index than the portion of the actuator surface, and wherein the portion of the actuator surface has a different refractive index than the gas or fluid, and wherein in use the relative refractive index is changed at a contacted portion of the light guide surface, thereby altering the light signal received by the receiver.

67. A key device according to claim 66, whereby said receiver is configured to output a signal indicative of the position of the contacted portion of the light guide surface.

68. A key device according to claim 66, wherein said actuator comprises a key or button.

69. A key device according to claim 66, wherein said device further comprises a key which moves said actuator in use.

70. A key device according to claim 68, wherein said device comprises a plurality of keys.

71. An apparatus, comprising:
transmitter means for transmitting a light signal;
receiver means for receiving the light signal;
light guiding means for guiding light, said light guiding means having a surface for internally reflecting the light signal from the transmitter means to the receiver means; and
actuator means for actuating, said actuator means having a surface with at least a portion of which is movable between a first position spaced apart from a portion of the light guide surface, with a gas or fluid therebetween, and a second position in contact with the portion of the light guide surface, the portion of the light guide surface having a higher refractive index than the portion of the actuator surface, and the portion of the actuator surface having a different refractive index than the gas or fluid,
wherein in use the relative refractive index is changed at the contacted portion of the light guide surface, thereby altering the light signal received by the receiver means.
